(19) United States
(12) Patent Application Publication
(10) Pub. No.: US 2008/0041731 A1
(43) Pub. Date: Feb. 21, 2008

(54) PROCESS FOR REGENERATING ELECTROLYTES IN ELECTROCHEMICAL POLISHING APPLICATIONS

(75) Inventor: Hans-Joachim Konietzni, Memmingen (DE)

Correspondence Address: KENNAMETAL INC., 1600 TECHNOLOGY WAY, LATROBE, PA, 15650-0231, US

(73) Assignee: Extrude Hone Corporation, Latrobe, PA (US)

(21) Appl. No.: 11/465,839

(22) Filed: Aug. 21, 2006

(51) Int. Cl. B23H 3/10

(52) U.S. Cl. 205/673

(57) ABSTRACT

A process for regenerating electrolytes containing high sodium chloride concentrations for reuse in the production of an electrochemical polishing process of aluminum surfaces.

### BACKGROUND OF THE INVENTION

1. Field of the Invention

The present invention relates to electrochemical polishing, and more particularly, to a process for regenerating electrolytes for reuse in an electrochemical polishing process of metallic workpieces.

2. Description of Related Art

Electrochemical machining (ECM) is a process for removing metal by electrochemical dissolution of an anodically polarized workpiece which is one part of an electrolytic cell. ECM is based on a controlled anodically electrochemical dissolution process of a workpiece (anode) with a tool (cathode) in an electrolyte cell during an electrolysis process.

Electrolysis is a chemical process wherein an electric current is passed between two wires dipped in a liquid solution. Such solution is termed an electrolyte. The wires are called electrodes, the one with positive polarity being the anode, and the one with negative polarity being the cathode. Typical applications of electrolysis are the electroplating and electroforming processes in which metal coatings are deposited upon a surface of a cathode-workpiece.

Examples of anodic dissolution operations are electrochemical polishing (ECP), electrochemical deburring (ECD) and electrochemical machining (ECM), which is electroplating in the reverse. In ECP, for example, the workpiece which is to be polished is made to be the anode in an electrolytic cell. Instead of depositing another metal on the workpiece surface, the action of electrochemical polishing is to remove a surface layer, thereby creating a smooth and polished surface. The production of an electrochemically polished surface is usually associated with the random removal of atoms from the anode workpiece, whose surface has become covered with an oxide film.

The type of electrolyte used in electrochemical polishing is an important factor in obtaining a high quality polished finish on a surface of a workpiece. For example, sodium chloride electrolyte tends to produce an etched, matte finish with steel and nickel alloys. Further, electrolyte concentration can alter the current density and velocity of the electrolyte, which affects the rate of removal of atoms from the anode workpiece. For example, a sodium chloride electrolyte having a concentration greater than 50% in an aqueous solution can cause a reduction in the current density characteristics of the electrolyte, thus affecting the surface finish of the workpiece. Nonetheless, for certain metals, the mechanism for obtaining a smooth and polished surface in electrochemical polishing applications are still not completely understood. For example, with nickel based alloys, the formation of a nickel oxide film on the metal surface is considered to be a prerequisite for obtaining a smooth and polished surface. In other instances, the formation of an oxide film on a metal surface leaves a poor surface finish. For example, with titanium in a sodium nitrate electrolyte, an oxide film is formed on the metal surface, thus resulting in a dull surface finish.

It has been found in the electrochemical polishing of aluminum and aluminum based alloys that an electrolyte having a high sodium ion (preferably sodium chloride) concentration of greater than 50% in an aqueous solution results in a smooth, highly reflective and polished surface finish of the aluminum.

The waste product produced from an electrochemical polishing process is often referred to as metal hydrolysates. These hydrolysates are typically filtered from the electrolyte solution in order for the electrolyte to be reused. Typical filtering techniques include centrifugation, filtration and sedimentation. In the electrochemical polishing of aluminum workpieces, the hydrolysates are generally in the form of finely dispersed aluminum hydrolysates. However, because the specific gravity of the aluminum hydrolysates and the sodium chloride electrolyte are similar, it is difficult to achieve efficient separation of the electrolyte from the hydrolysates using these known techniques. U.S. Pat. No. 4,737,250 describes a process of regenerating electrolytes containing sodium nitrate by adding iron (III) nitrate to the electrolyte such that the hydrolysates are predominantly precipitated in coarse flocculent form. Even after the separation process, minor amounts of the metal hydrolysates are still present in the electrolyte. This amount may not affect the shape of a workpiece in ECM applications. However, in electrochemical polishing applications, even minor amounts of hydrolysates remaining in the electrolyte can have a substantial effect on the surface finish. For example, a sodium chloride electrolyte containing about 1.0% by weight of hydrolysates results in a cloudy, matte surface finish of an aluminum workpiece. Because the electrolyte is a critical factor in obtaining a smooth, highly reflective and polished surface finish, the reuse of an electrolyte generally does not occur in critical electropolishing applications such as aluminum. Therefore, it is an object of the present invention to separate the finely dispersed aluminum hydrolysates from a sodium chloride electrolyte whereby the separated or regenerated electrolyte is substantially contaminant-free for reuse in an electrochemical polishing process.

### SUMMARY OF THE INVENTION

The present invention provides for a process for using regenerated electrolytes containing high concentrations of sodium chloride in the production of an electrochemically-polished aluminum surface. The process includes adding iron (III) nitrate to an electrolyte mixture containing finely dispersed metal hydrolysates thereby causing the formation of coarsely flocculant particles which bind the finely dispersed portions by adsorption and inclusion. In the presence of high salt (i.e., sodium chloride) concentration levels, the precipitates are readily filterable, sedimentable and able to be centrifuged, thus resulting in a substantially contaminant-free regenerated electrolyte solution.

### DETAILED DESCRIPTION OF THE INVENTION

The present invention is a process for the addition of iron (III) nitrate to a high sodium chloride aqueous solution (electrolyte) in an amount commensurate to the amount of metal hydrolysates obtained in the electrochemical polishing of aluminum, to precipitate the hydrolysates to a surprisingly effective degree. The process is used to regenerate electrolytes in which the sodium chloride (or other sodium salt) concentration in aqueous solution is, for example, greater than 50%, preferably ranging between 50-60%. The high salt concentration of the electrolyte is not only an important factor for obtaining a high quality surface finish in the electrochemical polishing of aluminum, but also itself contributes to the new and unexpectedly improved precipitation of unwanted hydrolysates overall. In theory, without intention of being bound by the theory, the flocculation of the hydrolysates in the presence of the high salt content is enhanced as contrasted with relatively lower salt contents, possibly because the ready availability of sodium ions creates a complex with the hydrolysates to enhance precipitation of the hydrolysates.

In the prior art process for regenerating electrolytes as described in U.S. Pat. No. 4,737,250, the metal hydrolysates are separated from a sodium nitrate electrolyte by adding iron (III) nitrate followed by a known separation method. It is believed that about 10-25% of the finely dispersed hydrolysates do not bind to the iron (III) nitrate and, therefore, these contaminants remain in the electrolyte after the separation process. Even minor amounts of metal hydrolysates remaining in the electrolyte can adversely effect the reflectiveness and brightness of a surface in electrochemical polishing applications, however, for example, when minor amounts of the aluminum hydrolysates (e.g., about 1.0 wt. %) remain in the electrolyte during electrochemical polishing of aluminum surfaces, a white cloudy film develops on the surface, thereby substantially reducing the polished appearance of the aluminum surface.

The addition of iron (III) nitrate to an electrolyte mixture containing high sodium chloride concentrations produces a substantially contaminant-free electrolyte when separated (e.g., filtration, sedimentation or centrifugation). The added iron (III) nitrate undergoes hydrolysis and the ionic products thus formed in turn complex the metal hydrolysate impurities to form coarsely flocculent particles. The hydrolysis reaction, in theory, also causes the sodium ions to create a complex with the remaining hydrolysates that did not bind with the iron (III) nitrate, thus enhancing precipitation of the remaining hydrolysates. The coarsely flocculent particles and the sodium complexes are then easily separated from the electrolyte using known separation methods including filtration, sedimentation and centrifugation. Although the salt concentration of the electrolyte is slightly decreased as a result of flocculation and separation, the resulting electrolyte is substantially contaminant-free, and a minor amount of restorative salt may be added. The regenerated electrolyte can then be added back into an electrolyte reservoir in an electrochemical polishing process without affecting the quality of the polished surface.

The following example is illustrative.

### EXAMPLE 1

In the electrochemical polishing of aluminum parts such as automobile wheel rims, an electrolyte containing about 60% sodium chloride is used. After the polishing process, at least one-half pound of aluminum hydrolysates are produced per rim, thus forming a sludge or gelatinous mixture containing the electrolyte (aqueous sodium chloride) and finely dispersed aluminum hydrolysates. This electrolyte mixture may have at least 5.0% by weight of solids (hydrolysates) based upon the total weight of the mixture. Iron (III) nitrate is added to the electrolyte mixture in an amount ranging from 10 to 100 mg of iron (III) nitrate per liter of electrolyte mixture. The mixture reacts thus forming both coarsely flocculent particles and sodium ion complexes with the hydrolysates. Centrifugation of the mixture results in a substantially contaminant-free electrolyte. Even with a slight decrease in salt concentration, restorative salts do not have to be added until the salt concentration of regenerated electrolyte falls below 50%.

By measuring the electric power, which is a measure of the removal of metal, it is possible to meter in the iron (III) nitrate which is to be added to the electrolyte in an electropolishing circulation system in a controlled manner. The addition of the iron (III) nitrate is expediently effective in the electrolyte reservoir or in a separate circulation system connected thereto, in which the hydrolysates are likewise removed.

Although the present invention has been described with references to specific details of certain embodiments thereof, it is not intended that such details should be regarded as limitations upon the scope of the invention except in so far as they are included in the claims.

1. A process for reusing regenerated electrolytes containing high concentrations of sodium chloride which are used in the electrochemical polishing of aluminum workpieces comprising:
adding ferrate nitrate to the electrolyte in an amount such that finely dispersed aluminum hydrolysates produced by the electrochemical polishing are precipitated predominantly in coarsely flocculant particles; and
separating both the coarsely flocculant particles and any remaining finely dispersed aluminum hydrolysates from the electrolyte, thereby resulting in a substantially contaminant-free electrolyte.

2. The process according to claim 1, wherein the electrolyte has a sodium chloride concentration in an amount of greater than 50% in an aqueous solution.

3. The process according to claim 2, wherein electrolyte has a sodium chloride concentration in an amount ranging between 50-60% in an aqueous solution.

4. The process according to claim 1, wherein sodium ion complexes are created with the remaining finely dispersed aluminum hydrolysates thereby enhancing separation of the hydrolysates from the electrolyte.

5. The process according to claim 1, wherein the separation step comprises centrifugation, filtration and sedimentation.

6. A process for reusing regenerated electrolytes containing high concentrations of sodium salt which are used in the electrochemical polishing of aluminum workpieces comprising:
adding ferrate nitrate to the electrolyte in an amount such that finely dispersed aluminum hydrolysates produced by the electrochemical polishing are precipitated predominantly in coarsely flocculant particles; and
separating both the coarsely flocculant particles and any remaining finely dispersed aluminum hydrolysates from the electrolyte, thereby resulting in a substantially contaminant-free electrolyte.

7. The process according to claim 6, wherein the sodium salt comprises sodium nitrate.

8. The process according to claim 7, wherein the electrolyte has a sodium nitrate concentration in an amount of greater than 50% in an aqueous solution.

9. The process according to claim 8, wherein the electrolyte has a sodium nitrate concentration in an amount ranging between 50-60% in an aqueous solution.

10. The process according to claim 6, wherein sodium ion complexes are created with the remaining finely dispersed aluminum hydrolysates thereby enhancing separation of the hydrolysates from the electrolyte.

11. A process for reusing regenerated electrolytes containing high sodium ion concentrations which are used in the electrochemical polishing of aluminum workpieces comprising:
adding ferrate nitrate to the electrolyte in an amount such that finely dispersed aluminum hydrolysates produced by the electrochemical polishing are precipitated predominantly in coarsely flocculant particles; and
separating both the coarsely flocculant particles and any remaining finely dispersed aluminum hydrolysates from the electrolyte, thereby resulting in a substantially contaminant-free electrolyte.

12. The process according to claim 11, wherein the electrolyte has a sodium ion concentration in an amount of greater than 50% in an aqueous solution.

13. The process according to claim 12, wherein the electrolyte has a sodium ion concentration in an amount ranging between 50-60% in an aqueous solution.
